(19) United States
(12) Patent Application Publication
(10) Pub. No.: US 2006/0293440 A1
(43) Pub. Date: Dec. 28, 2006

(54) Methods of preparing organic-inorganic hybrid binder compositions and nonwoven products

(75) Inventors: Alexander Tseitlin, Mississauga (CA); Robert Schmidt, Thornhill (CA); Elena Pisanova, Mississauga (CA)

Correspondence Address: BIRCH STEWART KOLASCH & BIRCH, PO BOX 747, FALLS CHURCH, VA, 22040-0747, US

(73) Assignee: Dynea Austria GmbH, Krems (AT)

(21) Appl. No.: 11/418,305

(22) Filed: May 5, 2006

Related U.S. Application Data
(60) Provisional application No. 60/678,213, filed on May 6, 2005.

(51) Int. Cl. C08L 29/04

(52) U.S. Cl. 524/557

(57) ABSTRACT

Methods of producing curable water-soluble organic-inorganic hybrid binder compositions that are based on the use of polyols containing a plurality of pendant hydroxyl groups and organooxysilanes. The curable water-soluble organic-inorganic hybrid binders prepared are useful in producing nonwoven products such as glass fiber products, polyester fiber products and mineral wool products.

This Nonprovisional application claims priority under 35 U.S.C. §119(e) on U.S. Provisional Application No(s). 60/678,213 filed on May 6, 2005, the entire contents of which are hereby incorporated by reference.

### FIELD OF THE INVENTION

The present invention relates to organic-inorganic hybrid binder compositions that are thermosetting resin compositions, methods for producing water-soluble organic-inorganic hybrid binders that are based on the use of organic polymers containing a plurality of pendant hydroxyl groups and organooxysilanes, and which organic-inorganic hybrid binders are useful for the manufacture of nonwoven products including glass fiber, polyester fiber and mineral wool products, such as insulation materials, glass fiber mats, filters and the like.

### BACKGROUND OF THE INVENTION

Phenol-formaldehyde binders have been the primary binders in the manufacture of fiberglass and mineral wool insulation. These binders are low-cost and easy to apply and readily cured. They provide a strong bond, and yet maintain elasticity and a good thickness recovery to obtain a full insulating value. However, there is a strong desire in the market for a binder based on chemistry other than HCHO. Though, there are a number of formaldehyde-free compositions that have been developed, there still exists a need for alternative fiberglass binder systems that provide the performance advantages of phenol-formaldehyde resins in a formaldehyde-free system.

Alternative chemistries have been developed to provide formaldehyde-free binder systems. Alkoxides or halosilanes are used for modification of organic polymers containing pendant hydroxyl groups in EP 0 581 576 to form films exhibiting high levels of physical properties such as tensile, hardness and tensile strength, and one of them is an organic-inorganic composition. A disadvantage of the disclosed process is that the reaction is conducted under substantially anhydrous conditions in organic solvent.

Silanes in conjunction with colloidal organic particles are disclosed in DE 196 47 369 A1 in the form of a nano composites for binding glass fibers, mineral fibers or wood materials. Silicon compounds in US 2004/0092189 A1 are also used as binders for the composites for building and automobile industry. In U.S. Pat. No. 5,780,530 there are disclosed thermosetting coating compositions containing a polyol resin, a curing agent reactive with the polyol, a hydrolyzate/polycondensate of tri- or tetraethoxysilane, and a catalyst. Silane in this application is used as a coupling agent.

Polyfunctional organic-inorganic compositions comprising linear and cyclic hydrosiloxanes in U.S. Pat. No. 6,844,394 are used as coating materials. The method disclosed utilizes a hydrosilylation reaction, which must be carried out at elevated temperatures in organic solvent, followed with removing the solvent by distillation.

ES 2174680 discloses low-density hybrid organic-inorganic compositions that are used for making a monolithic heat insulation materials.

Ethoxysilanes are described as additives to polycarboxy polymer binding resins in US 2005/021421 enhancing aging performance, particularly under hot, humid conditions.

The systems described in the above disclosures, have serious disadvantages as insulation binders, such as limited water dilutabilty, limited storage life, or emission potential adding to the volatile organic compounds (VOC) or other emissions during processing of the binder.

### SUMMARY OF THE INVENTION

The present invention relates methods for producing organic-inorganic hybrid binder compositions, comprising combining component (A) at least one polyol comprising at least one pendant hydroxyl groups, component (B) at least one organooxysilane, and a catalytic amount of component (C) an acid or a base. In addition, the present invention relates to the organic-inorganic hybrid binder compositions produced by the present methods. Also, the present invention relates to nonwoven products, such as glass fiber products, polyester fiber products and mineral wool products, such as insulation products, glass fiber mat products, filter products and the like prepared with the present organic-inorganic hybrid binder compositions.

The inventive methods for producing the organic-inorganic hybrid binders are characterized by their use of polyols and organooxysilanes to produce a water-soluble resin composition that comprises sol-gel products of the co-condensation of a water solution of the polyol with the silane containing a plurality of alkoxysilyl groups and optionally silanol groups, wherein the resultant compositions utilize a condensation reaction of silanol groups, which are formed in-situ, resulting from hydrolysis of the silane organooxy groups with each other and with hydroxyl groups possessed by the polyol.

The thermosetting resin compositions of the present invention are based on a system comprising a silicate component and an organic resin component chemically bonded through interaction of hydroxyl groups of the polyol and the silanol groups of the silicate component.

### DETAILED DESCRIPTION OF THE INVENTION

The following detailed description and examples are given in an effort to those desiring to practice the present invention, and as such should not be deemed to unduly limit the present invention or the equivalents encompassed thereby as set forth in the claims appended hereto, and the equivalents encompassed thereby. In this respect, those of ordinary skill in the art will realize that various minor changes may be made in the materials, procedures and methods set forth herein, without departing from the spirit or scope of the present invention.

Organic-Inorganic Hybrid Binder Compositions—Production Methods

The present invention is based on the Inventors' discovery of stable water-soluble thermosetting organic-inorganic hybrid binders for nonwovens that are obtained by hydrolysis of at least one organooxysilane followed by co-condensation of the resulting silanol(s) with at least one polyol in the presence of alkaline or acidic catalysts, to thereby form the stable water-soluble thermosetting organic-inorganic hybrid binders for nonwovens.

Thus, the present invention provides a method for producing a water-soluble thermosetting organic-inorganic hybrid binder that is useful in the manufacture of nonwoven products (e.g., glass fiber, polyester fiber and mineral wool products) on the basis of organic polymers containing plurality of pendant hydroxyl groups and organooxysilane.

In one embodiment, the inventive method provides for the production of an aqueous thermosetting organic-inorganic hybrid binder composition, comprising an aqueous mixture of a water-dilutable or dispersible adduct of a co-condensation reaction of at least one monomeric organooxysilane component and at least one polyol comprising at least two pendant hydroxyl groups, wherein the water-dilutable or dispersible adduct of the co-condensation reaction is a polyolsilane copolymer, and wherein the co-condensation reaction takes place in the presence of a catalytic amount of an inorganic or organic acid or a catalytic amount of an alkali.

The polyol can be linear, branched or cyclic and may be any of a wide variety of materials, including but not limited to at least one of a low molecular weight polyalcohol, a polyvinyl alcohol, a polysaccharide, and a carbohydrate. Preferably, the polyol is at least one of polyethylene glycol (to make 2,3-dihydroxydioxane), diethylene glycol, dialkylene glycol (to make an oligomeric condensation product) such as 1,2-propylene glycol, 1,3-propylene glycol, 1,2-butylene glycol, 1,3-butylene glycol, 1,4-butylene glycol, polyethylene glycols having the formula HO(CH₂CH₂O)ₙH where n is 1 to about 50, and the like, and their mixtures. Other suitable polyols (i.e. containing at least three hydroxy groups) can be used, such as glycerin, (to make 2,3-dihydroxy-5-hydroxymethyl dioxane) as well as unalkylated or partially alkylated polymeric glyoxal derived glycols such as poly (N-1′,2′-dihydroxyethyl-ethylene urea), dextrans, glyceryl monostearate, ascorbic acid, erythrobic acid, sorbic acid, ascorbyl palmitate, calcium ascorbate, calcium sorbate, potassium sorbate, sodium ascorbate, sodium sorbate, monoglycerides of edible fats or oils or edible fat-forming acids, inositol, sodium tartrate, sodium potassium tartrate, glycerol monocaprate, sorbose monoglyceride citrate, polyvinyl alcohol, α-D-methylglucoside, sorbitol, dextrose, and their mixtures.

It is most preferred to use polyvinyl alcohol (PVOH) as the polyol. The preferred number average molecular weight (Mn) for the polymers containing plurality of pendant hydroxyl groups is at least 5,000. It is more preferred that the Mn is 7,000 to 85,000. It is most preferred that the Mn is 10,000 to 25,000. The PVOH can be a partially hydrolyzed polyvinyl acetate, or a copolymer of ethenol and vinyl acetate. Fully hydrolyzed grades of PVOH, i.e., at least 98 mole % hydrolyzed, provide high tensile strength of the final product. However, these fully hydrolyzed grades are characterized by a higher viscosity of aqueous solutions. Preferably, the PVOH is from 70 mole % to 97 mole % hydrolyzed. More preferably, the PVOH is from 80 mole % to 90 mole % hydrolyzed.

The monomeric organooxysilane is at least one compound of the following general formula:
R¹ₙSi(OR²)₄₋ₙ

wherein R¹ and R² are each optionally substituted with at least one halogen and are independently selected from a C₁ to C₅ alkyl (such as methyl, ethyl, propyl or butyl) and aryl (such as phenyl, tolyl and the like); and n is 0-3,

wherein the majority of monomers has n=0 or 1 and the majority of R¹ and R² are C₁ to C₅ alkyl. Preferably, less than 2 mole % of all of the organooxysilane monomers have R¹ or R² as an aryl group. More preferably R¹ and R² are independently selected from a C₁ to C₅ alkyl and n =0-1. Most preferably, the monomeric organooxysilane is tetraethoxysilane (TEOS, a.k.a. tetraethylorthosilicate) and/or methyl(triethoxy)silane (MTEOS, a.k.a. methyl-triethylorthosilicate).

The mixture of polyol and monomeric organooxysilane produces a water-soluble resin composition that comprises sol-gel products of the co-condensation of a water solution of the organic polymer containing the plurality of pendant hydroxyl groups with the silane containing plurality of alkoxysilyl groups and optionally silanol groups, wherein the resultant compositions utilize a condensation reaction of silanol groups, which are formed in-situ, resulting from hydrolysis of silane alkoxy groups with each other and with hydroxyl groups possessed by the organic polymer. In other words, the cured composition contains at least two interpenetrating polymers—a crosslinked polymer (e.g. PVOH) containing alcohol groups (wherein at least some of the alcohol groups have reacted with siloxane or polysiloxane groups) and polysiloxane.

The condensation reaction takes place in the presence of a catalytic amount of an organic acid and/or inorganic acid or a catalytic amount of an alkali. Preferably, the amount of acid or alkali is about 1.25 wt % or less based on the total amount of polyol and organooxysilane. More preferably, the amount is about 0.85 wt % or less. The mixture undergoing the condensation reaction does not necessarily have to be heated, but is preferably heated to less then 100° C. to speed the reaction. More preferably, the mixture is heated to 50-75° C. Typically, completion of the reaction is signified by the solution becoming clear.

The reaction between the polyol component (A) and the monomeric organooxysilane component (B) is a two-stage process wherein both stages are performed in situ. At the first stage, the monomeric organooxysilane is hydrolyzed to a silanol, and then it condenses into polysiloxane and partially reacts with the hydroxyls of the polyol. It is preferred to use an acidic catalyst for component (C) because the reaction of the hydroxyls of the polyol performs better in an acidic media, so curing is performed at low pH. In the case of using an alkaline catalyst for component (C), the pH is shifted to acidic for curing prior to application on the substrate and curing itself takes longer at the same temperature.

In the inventive method, the acid is not specifically limited in amount (other than being present in a catalytic amount) or in type, although it is preferably selected from the group consisting of hydrochloric acid, sulfuric acid, phosphoric acid, formic acid, acetic acid, citric acid, propionic oxalic acid, p-toluenesulfonic acid, benzoic acid, phthalic acid and maleic acid.

Likewise, the base is not specifically limited in amount (other than being present in a catalytic amount) or in type, although it is preferably selected from the group consisting of sodium hydroxide, potassium hydroxide, calcium hydroxide, tin compounds (dibutyltin dilaurate, dibutyltin dioctoate and dibutyltin diacetate) and the like.

In order to reduce the corrosivity of the aqueous thermosetting organic-inorganic hybrid binder composition, it is preferred that the aqueous composition comprising components (A), (B) and (C) is neutralized to a pH of 4-9 after completion of the reaction between the polyol and the monomeric organooxysilane. Preferably, the pH is neutralized to 6-8 after completion of reaction. Depending upon the final pH of the reaction mixture, any effective acid or base can be used for neutralization. In the event that the reaction is catalyzed with acid, the neutralization can be carried out with a basic salt (such as an alkaline hydroxide in a concentration of less than 2N, preferably less than IN) or a nitrogenous base such as an ethanolamine (e.g. diethanolamine). The use of a nitrogenous base is especially preferred because it gives less ash content, does not dilute the product (alkalis have to be used in concentrations not higher than 1N), and overall the final product has better mechanical properties.

Organic-Inorganic Hybrid Binder Compositions—Methods of Use

The water-soluble thermosetting organic-inorganic hybrid binder compositions of the instant invention are advantageously used as binders with glass fiber products, polyester fiber products and mineral wool products, including fiber glass materials, insulation materials, and the like. Advantages of the water-soluble thermosetting organic-inorganic binders are that no hazardous emissions are produced thereby during manufacture, or after production, and at the same time they allow for improved mechanical properties in products produced therewith. It is noted that stability of the binder composition can be improved by neutralizing to a pH of 4-9 (preferably about 6-8) after completion of reaction.

The curable (thermosetting) water-soluble organic-inorganic hybrid binder compositions are generally aqueous compositions that are applied to a nonwoven material or substrate by conventional techniques such as, for example, spraying, padding, saturating, roll coating, beater deposition, or the like, followed by subsequent curing of the compositions to form a non-woven product. Preferably, the aqueous composition is prepared and stored in a concentrated form having 30-50 wt % solids, wherein the wt % is based on the weight of the entire aqueous composition. The viscosity of the concentrated form of the aqueous composition is preferably 750-4,500 centipoise as measured at 20° C. Immediately prior to application, it is preferred that the aqueous composition is diluted to have 2-12 wt % solids. The viscosity of the diluted form of the aqueous composition is preferably 5-7 centipoise as measured at 20° C.

It was found that the aqueous composition is stable for at least two weeks at room temperature and at least two months when refrigerated (at ˜4° C.).

More particularly, the aqueous water-soluble organic-inorganic hybrid binder composition, after it is applied to a nonwoven material or substrate is heated to result in drying and curing of the aqueous thermosetting resin composition. The duration and temperature of heating affect the rate of curing and properties development of the treated substrate. Heat treatment (curing) of the aqueous (waterborne) thermosetting resin binder composition can take place at temperatures from Room Temperature (about 23° C.) up to about 150° C., for a time period of from a few minutes (e.g., 5 - 10 minutes) up to an hour, or a few hours, or more (e.g., 1-12 hours), depending on the specific materials and temperatures utilized. Heat treatment at about 100° C. to about 150° C. for a time period of 5 to 10 minutes is considered preferable and recommended. Curing at temperatures of higher than 150° C. can result in rapid water evaporation and lead to a considerably dry composition, but which is not a substantially cured composition.

In an embodiment of the invention, the curable aqueous organic-inorganic hybrid binder composition includes other components, e.g. emulsifiers, plasticizers, anti-foaming agents, biocide additives, anti-mycotics including, e.g., fungicides and mold inhibitors, adhesion promoting agents, colorants, waxes, antioxidants, corrosion inhibitors and combinations thereof. It is envisioned that a polycarboxy polymer (such as a homopolymer or copolymer prepared from unsaturated carboxylic acids including but not limited to acrylic acid, methacrylic acid, crotonic acid, maleic acid and the like) can be added to the mixture of components (A) and (B) and in small amounts such as a ratio of the number of equivalents of carboxy, anhydride, or salts thereof of the polyacid to the number of equivalents of hydroxyl in the polyol being 0.001/1 to 0.94/1. It is most preferred that the curable aqueous composition does not contain essentially any polycarboxy polymer.

In an embodiment of the invention, the curable aqueous composition includes solvents other than water to promote intimate mixing of the components.

The following examples are provided as an aid to those desiring to practice the instant invention as disclosed herein, and are not to be construed as being limiting thereto.

### EXAMPLE 1

500 g of 25% by weight aqueous polyvinyl alcohol (Celvol 205) and 10 g of 1N hydrochloric acid were charged into a kettle incorporating a stirrer and heating means, and mixed at room temperature. 110 g of tetraethoxysilane added to the mix with stirring, and the mix is heated to 60-65 degrees C. for about 6 hours until the solution clears (signifying that the reaction has essentially completed) the reaction mixture is then neutralized with diethanolamine to pH=6-8.

### EXAMPLE 2

500 g of 30% by weight aqueous polyvinyl alcohol (Celvol 502) and 10 g of citric acid were charged into a kettle incorporating a stirrer and heating means, and mixed at room temperature. 250 g of tetraethoxysilane added to the mix with stirring, and the mix is heated to 60-65 degrees C. for about 2 hours until the solution clears (signifying that the reaction has essentially completed).

### EXAMPLE 3

500 g of 25% by weight aqueous polyvinyl alcohol (Celvol 205) and 10 g of 1N sodium hydroxide were charged into a kettle incorporating a stirrer and heating means, and mixed at room temperature. 110 g of tetraethoxysilane added to the mix with stirring, and the mix is heated to 60-65 degrees C. for about 3 hours until the solution clears (signifying that the reaction has essentially completed) the reaction mixture is then neutralized with 1N HCl to pH=6-8.

### EXAMPLE 4

150 g of 30% by weight aqueous polyvinyl alcohol (Celvol 502), 15 g of glycerol and 3 g of citric acid were charged into a kettle incorporating a stirrer and heating means, and mixed at room temperature. 80 g of tetraethoxysilane added to the mix with stirring, and the mix is heated to 60-65 degrees C. for about 2 hours until the solution clears (signifying that the reaction has essentially completed).

### EXAMPLE 5

### Treatment of Nonwovens and Tensile Testing of Treated Nonwovens

The binder of Example 1 was applied to a glass fiber specimen (WHATMAN 934-AH) by saturation method and the excess binder was recovered by vacuum, and the specimen was then cured in the oven at 180° C. for 10 minutes. The binder add-on was 28% (dry binder weight based on the weight of glass).

The cured sheet was then cut into 1 inch by 4 inch strips tested individually for dry tensile strength by Lloyd Instruments LRX PLUS tensile tester at a crosshead speed of 2 inches/minute. Wet tensile strength was measured on strips soaked in 85° C. water for 10 minutes with a Lloyd Instruments LRX PLUS tensile tester at a crosshead speed of 2 inches/minute. The test results are presented in Table 1 along with those of two comparatives (A and B).

TABLE 1
Tensile Testing of Treated Nonwovens

| | Dry Tensile | Wet Tensile | |
|---|---|---|---|
| Sample | (kgf) | (kgf) | Retention (%) |
| Example 1 | 5.71 | 5.64 | 98.7 |
| Comparative A¹ | 5.52 | 4.68 | 84.9 |
| Comparative B² | 5.48 | 4.7 | 85.8 |

¹“Comparative A” contains a phenol formaldehyde binder.
²“Comparative B” contains a polyacid-polyol binder from U.S. Pat. No. 5,661,213.

The tensile testing results reported in Table 1 show that the Inventive Example 1 provides an advantageous dry tensile and wet tensile strength, and also show an advantageous amount of retention.

What is claimed is:

1. A curable organic-inorganic aqueous binder composition prepared by a process comprising combining the following components:
(A) a polyol,
(B) an organooxysilane, and
a catalytic amount of (C) an acid or a base.

2. The curable organic-inorganic aqueous binder composition according to claim 1, wherein the polyol is at least one linear, branched or cyclic organic compound having at least two alcohol groups.

3. The curable organic-inorganic aqueous binder composition according to claim 1, wherein the polyol is at least one of a low molecular weight polyalcohol, a polyvinyl alcohol, a polysaccharide, and a carbohydrate.

4. The curable organic-inorganic aqueous binder composition according to claim 1, wherein the polyol is a polyvinyl alcohol formed from a partially hydrolyzed polyvinyl acetate, or a copolymer of ethenol and vinyl acetate, and wherein the polyvinyl alcohol has been hydrolyzed from 70 mole % to 97 mole %

5. The curable organic-inorganic aqueous binder composition according to claim 1, wherein the organooxysilane is at least one compound of the following general formula:
R¹ₙSi(OR²)₄₋ₙ
wherein R¹ and R² are each optionally substituted with at least one halogen and are independently selected from a C₁ to C₅ alkyl and aryl; and n is 0-3,
wherein the majority of monomers has n =0 or 1 and the majority of R¹ and R² are C₁ to C₅ alkyl.

6. The curable organic-inorganic aqueous binder composition according to claim 5, wherein R¹ and R² are independently selected from a C₁ to C₅ alkyl and n=0-1.

7. The curable organic-inorganic aqueous binder composition according to claim 1, wherein the process further comprises a step of neutralizing the composition to have a pH of 4-9 after component (A) has reacted with component (B).

8. The curable organic-inorganic aqueous binder composition according to claim 7, wherein component (C) is an acid and wherein the neutralizing step is performed with a nitrogenous base.

9. The curable organic-inorganic aqueous binder composition according to claim 7, in a concentrated form having a 30-50 wt % solids based on the total weight of the curable aqueous composition.

10. The curable organic-inorganic aqueous binder composition according to claim 7, in a diluted form having a 2-12 wt % solids based on the total weight of the curable aqueous composition.

11. A nonwoven product, prepared by a process comprising the steps of:
applying to a nonwoven substrate, the curable organic-inorganic aqueous binder composition of claim 10 to form a product and heating the product to effect cure.

12. The nonwoven product of claim 11, wherein the nonwoven substrate is glass fiber, polyester fiber or mineral wool.

13. The nonwoven product according to claim 11, wherein the nonwoven product is a fiberglass insulation material, a fiberglass mat or a fiberglass filter material.

14. The nonwoven product according to claim 11, wherein the nonwoven product is polyester fiber filtration material.

15. A method of forming a curable organic-inorganic aqueous binder composition comprising combining the following components:
(A) a polyol,
(B) an organooxysilane, and
a catalytic amount of (C) an acid or a base.

16. The method according to claim 15, wherein the polyol is at least one of a low molecular weight polyalcohol, a polyvinyl alcohol, a polysaccharide, and a carbohydrate.

17. The method according to claim 15, wherein the organooxysilane is at least one compound of the following general formula:
R¹ₙSi(OR²)₄₋ₙ
wherein R¹ and R² are each optionally substituted with at least one halogen and are independently selected from a C₁ to C₅ alkyl and aryl; and n is 0-3, wherein a majority of the monomers has n=0 or 1 and a majority of the R¹ and R² are C₁ to C₅ alkyl.

18. A method of forming a nonwoven product comprising the steps of:
forming a curable organic-inorganic aqueous binder composition by combining the following components:
(A) a polyol,
(B) an organooxysilane, and
a catalytic amount of (C) an acid or a base,
neutralizing the pH of the curable aqueous composition, and
applying to a nonwoven substrate, the neutralized curable aqueous composition to form a product, and
heating the product to effect cure.

19. The method according to claim 18, wherein the neutralization step is performed with a nitrogenous base.

20. The method according to claim 18, wherein the nonwoven substrate is glass fiber, polyester fiber or mineral wool.
